(19) United States
(12) Patent Application Publication
(10) Pub. No.: US 2006/0139163 A1
(43) Pub. Date: Jun. 29, 2006

(54) Linear seismic-acoustic system for detecting intruders in long and very narrow perimeter zones

(76) Inventor: Alexander Pakhomov, Yonkers, NY (US)

Correspondence Address: Ilya Zborovsky, 6 Schoolhouse Way, Dix Hills, NY, 11746, US

(21) Appl. No.: 11/011,219

(22) Filed: Dec. 14, 2004

(51) Int. Cl. G08B 19/00; G08B 13/00

(52) U.S. Cl. 340/522; 340/566

(57) ABSTRACT

For detecting intruders in long and very narrow perimeter zones two elongated sensitive elements extending in a direction of their elongation and are spaced form one another in a transverse direction so as to define therebetween an alarm zone which is narrower than a detection zone in which the sensitive elements are located, a processing unit is connected with the sensitive elements so as to receive a signal from the respective one of the sensitive element when an intruder crosses the sensitive element, and to process the signals to determine whether an intruder is in the detection zone or in the alarm zone, and an interface is provided operative for outputting an output signal produced by the processing unit as a result of processing of the signals from the sensitive elements.

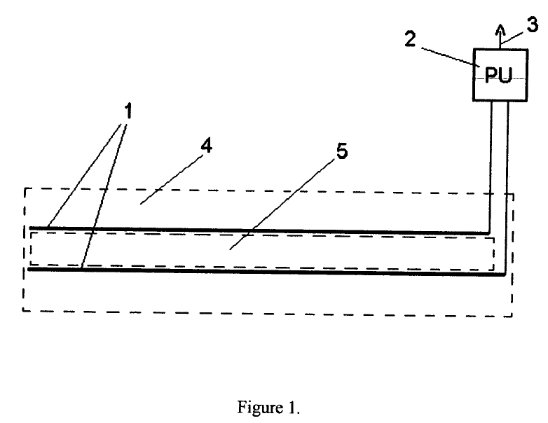

### BACKGROUND OF THE INVENTION

The present invention relates to a system for and a method of detecting intruders.

In particular, it relates to a system for and a method of detecting intruders in long and very narrow perimeter zones.

Systems and methods of detection intruders are known, such as for example as disclosed in our U.S. Pat. Nos. 6,529,130 and 6,664,894. It is believed that the existing systems and methods can be further improved.

### SUMMARY OF THE INVENTION

Accordingly, it is an object of the present invention to provide a system for and a method of detecting intruders, which is a further improvement of the existing systems and methods.

More particularly, it is an object of the present invention to provide a system for and a method of detecting intruders, which is specifically suitable for long and very narrow perimeter zones.

In keeping with these objects and with others which will become apparent hereinafter, one feature of the present invention resides, briefly stated, in a linear seismic-acoustic sensing system for detecting intruders in long and very narrow perimeter zones, comprising two elongated sensitive elements extending in a direction of their elongation and spaced from one another in a transverse direction so as to define therebetween an alarm zone which is narrower than a detection zone in which said sensitive elements are located and to produce signals when an intruder crosses said sensitive elements; a processing unit connected with said sensitive elements so as to receive a signal from the respective one of said sensitive elements when an intruder crosses said sensitive element, and to process said signals to determine whether an intruder is in said detection zone; or in said alarm zone and an interface operative for outputting an output signal produced by said processing unit as a result of said processing from said sensitive elements.

Another feature of the present invention resides, briefly stated, in a method of detecting an intruder in long and very narrow perimeter zones, comprising the steps of providing two elongated sensitive elements extending in a direction of their elongation and spaced from one another in a transverse direction so as to define therebetween an alarm zone which is narrower than a detection zone in which said sensitive elements are located and to produce a signal when an intruder crosses said sensitive elements; processing by a processing unit connected with said sensitive elements the signals received from a respective one of said sensitive element when an intruder crosses said sensitive element, to determine whether an intruder is in said detection zone or in said alarm zone; and outputting by an interface an output signal produced by said processing unit as a result of said processing of the signals from said sensitive elements.

When the system is designed and the method is performed in accordance with the present invention, it is possible to attack intruders in long and very narrow perimeter zones in a reliable manner.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view schematically showing an inventive system that realizes a method in accordance with the present invention.

### DESCRIPTION OF THE PREFERRED EMBODIMENTS

A linear seismic-acoustic system for detecting intruders in long and very narrow perimeter zones includes two sensitive elements that are identified with reference numeral 1. Each of the sensitive elements con be formed with the seismic string up to 120-160 m length and formed for example as a line geophones connected in parallel, or as a vibration sensitive cable or so-called microphone cable, tribolectric cable, fiber optic cable up to 300-350 m length. The system further has a processing unit that is identified with reference numeral 2. The processing unit has an interface 3 connecting the processing unit to a further integrated system.

Reference numeral 4 identifies a detection zone in which the detection can be performed in accordance with the present invention, and reference numeral 5 identifies an alarm zone.

The connection of the sensitive elements 1 with the processing unit 2 can be performed by any wire-or wireless interface 3 into an integrated system. The connections can be performed as disclosed for example in U.S. Pat. No. 6,664,894.

The processing unit performs processing of signals in accordance with an algorithm disclosed in our U.S. Pat. No. 6,529,130. As a result of processing in accordance with this algorithm, the processing unit makes the decision about a presence of a walking, running, jumping or crawling person in the detection zone 4 which can be a strip with a width of 20-40 m. This strip is located symmetrically relative to the sensitive elements 1.

In addition to the processing disclosed in the above mentioned U.S. Pat. No. 6,529,130, at least once in two seconds an absolute value of a difference of times of arrival of signals from the intruder (walking, running, jumping or crawling a person) to the sensitive element 1 is determined. This absolute value of the difference of the times of arrival is compared with a threshold. If this absolute value is less than the threshold, a signal alarm is triggered which means that the intruder is located in the alarm zone 5 located between the sensitive elements 1. When the distance between the sensitive elements is 45 meter, the value of the corresponding threshold is within 0.01-0.03 sec.

A sign of the difference of times of the arrival of the signal to the sensitive element, which took place two seconds before the triggering of the signal alarm, indicates the side “exterior” or “interior”, from which the intruder intruded into the alarm zone 5. In particular, if the signal arrived first to the exterior sensitive element, this means that the intruder entered the alarm zone from the exterior side. If the signal first arrived to the interior sensitive element, this means that the intruder intruded into alarm zone from the Interior side.

It will be understood that each of the elements described above, or two or more together, may also find a useful application in other types of constructions differing from the types described above.

While the invention has been illustrated and described as embodied in linear seismic-acoustic system for detecting intruders in a long and very narrow perimeter zones, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A linear seismic-acoustic seismic system for detecting intruders in long and very narrow perimeter zones, comprising two elongated sensitive elements extending in a direction of their elongation and spaced from one another in a transverse direction so as to define therebetween an alarm zone which is narrower than a detection zone in which said sensitive elements are located and to produce signals when an intruded crosses said sensitive elements; a processing unit connected with said sensitive elements so as to receive a signal from the respective one of said sensitive element when an intruder crosses said sensitive element, and to process said signals to determine whether an intruder is in said detection zone or in said alarm zone; and an interface operative for outputting an output signal produced by said processing unit as a result of processing of said signals received from said sensitive elements.

2. A linear seismic-acoustic system as defined in claim 1, wherein each of said sensitive elements includes a plurality of sensitive members located along each of said sensitive elements.

3. A linear seismic-acoustic system as defined in claim 1, wherein each of said elements is formed as an element selected from the group consisting of a seismic line and a vibration-sensitive cable.

4. A linear seismic-acoustic system as defined in claim 3, wherein said seismic line includes a plurality of geophones.

5. A linear seismic-acoustic system as defined in claim 3, wherein said cable is a cable selected from the group consisting of a triboelectric cable, a microphone cable, and an optofiber cable.

6. A linear seismicacoustic system as defined in claim 1, wherein said processing unit is formed so that an absolute value of a difference of times of receiving signals from an intruder to said sensitive elements is determined at least once in two seconds, and compared with a predetermined threshold so that when the absolute value is less than the threshold, an alarm signal is generated, indicative of a presence of an intruder in said alarm zone.

7. A linear seismic-acoustic system as defined in claim 6, wherein a distance between said sensitive elements is substantially 4-5 meter, while said threshold is equal to 0.01-0.03 seconds.

8. A linear seismic-acoustic system as defined in claim 1, wherein said processing unit is operative so as to determine a side from which an intruder intruded into said alarm zone, so that when a signal reached an interior sensitive one of said elements an intruder intruded into said alarm zone from an interior side, and when the signal reached an exterior one of said sensitive elements an intruder intruded into said alarm zone from an exterior side.

9. A method of detecting an intruder in long and very narrow perimeter zones, comprising the steps of providing two elongated sensitive elements extending in a direction of their elongation and spaced from one another in a transverse direction so as to define therebetween an alarm zone which is narrower than a detection zone in which said sensitive elements are located and to produce signals when an intruded Mosses said sensitive elements; processing by a processing unit connected with said sensitive elements signals from a respective one of said sensitive elements when an intruder crosses said sensitive element, to determine whether an intruder is in said detection zone or in said alarm zone; and outputting by an interface an output signal produced by said processing unit as a result of processing of said signals received from said sensitive elements.

10. A method as defined in claim 9; and further providing in each of said sensitive elements a plurality of sensitive members located along each of said sensitive elements.

11. A method as defined in claim 9; and further comprising forming each of said elements is formed as an element selected from the group consisting of a seismic string and a vibration-sensitive cable.

12. A method as defined in claim 9; and further comprising forming said seismic string with a plurality of geophones.

13. A method as defined in claim 9, wherein said cable as a cable selected from the group consisting of a dry or electric cable, a microphone cable, and an optofiber cable.

14. A method as defined in claim 9; and further comprising forming said processing unit so that an absolute value of a difference of times of receiving signals from an intruder to said sensitive elements is determined at least once in two seconds, and compared with a predetermined threshold so that when the absolute value is less than the threshold, an alarm signal is generated, indicative of a presence of an intruder in said alarm zone.

15. A method as defined in claim 9; and further comprising a distance from said sensitive elements to be substantially 45 meter, while said threshold is equal to 0.1-0.3 seconds.

16. A method as defined in claim 9; and further comprising forming said processing unit so that it is operative to determine whether an intruder intruded into said alarm zone from outside or from inside, so that when a signal reached an interior sensitive element an intruder intruded into said alarm from an interior side, and when the signal reached an exterior sensitive element first an intruder intruded into said alarm zone from an exterior side.
